(19) United States
(12) Patent Application Publication
(10) Pub. No.: US 2026/0103420 A1
(43) Pub. Date: Apr. 16, 2026

(54) GLASS AND METHOD FOR MANUFACTURING GLASS

(71) Applicant: AGC Inc., Tokyo (JP)

(72) Inventors: Satoru KURATA, Tokyo (JP); Tomonori KIMURA, Tokyo (JP); Takanori FUKUSHI, Tokyo (JP)

(73) Assignee: AGC Inc., Tokyo (JP)

(21) Appl. No.: 19/419,813

(22) Filed: Dec. 15, 2025

Related U.S. Application Data
(63) Continuation of application No. PCT/JP2024/019627, filed on May 29, 2024.

(30) Foreign Application Priority Data
Jun. 16, 2023 (JP) 2023-099340

(51) Int. Cl. C03B 23/03; C03C 3/062; C03C 3/064; C03C 3/068; G02B 6/10

(52) U.S. Cl. CPC C03B 23/0302; C03C 3/062; C03C 3/064; C03C 3/068; C03B 2215/48; G02B 6/10

(57) ABSTRACT

Even when a curved surface portion is formed on glass having a high refractive index, deterioration of optical characteristics is suppressed. A glass (10) has a refractive index n_{d} of 1.77 or more, an internal transmittance of 10 mm in thickness with respect to light having a wavelength of 460 nm of 89% or more, a curved surface portion (13) having a curvature radius of 10000 mm or less in at least a part of a peripheral portion, and a thickness deviation of 1% or less of a maximum thickness.

### CROSS-REFERENCE TO RELATED APPLICATION(S)

This application is a continuation of International Application No. PCT/JP2024/019627, filed on May 29, 2024 which claims the benefit of priority of the prior Japanese Patent Application No. 2023-099340, filed on Jun. 16, 2023, the entire contents of which are incorporated herein by reference.

### BACKGROUND OF THE INVENTION

### 1. Field of the Invention

The present invention relates to a glass and a method for manufacturing a glass.

### 2. Description of the Related Art

In recent years, glass having a high refractive index has been required. In particular, for example, a head mounted display used for augmented reality (AR), virtual reality (VR), mixed reality (MR), or the like is required to realize a wide viewing angle (FOV). Since the viewing angle of the head mounted display depends on the refractive index of the light guide material used for the display portion, a light guide plate having a high refractive index is used.

In addition, it is proposed that a light guide plate used for a glasses-type display has a curvature in an image propagation direction to increase a viewing angle even with the same material as compared with a flat plate, in Anastasiia Kalinina, Andrey Putilin, “Wide-field-of-view augmented reality eyeglasses using curved wedge waveguide” Proc. SPIE 11350, Digital Optics for Immersive Displays II, 1135005 (Apr. 14, 2020), <https://doi.org/10.1117/12.2559320>. JP 2016-121050 A describes a method for manufacturing a glass formed body having a curved surface portion by bending forming.

However, when glass having a high refractive index is formed by bending, the plate thickness distribution of the glass varies, and there is a problem that optical characteristics are deteriorated such that image quality is deteriorated or chromatic aberration is increased as compared with a flat plate-like light guide plate. Therefore, even when a curved surface portion is formed on glass having a high refractive index, it is desired to suppress deterioration of optical characteristics.

### SUMMARY OF THE INVENTION

The glass of the present disclosure has a refractive index n_{d} of 1.77 or more, an internal transmittance of 10 mm in thickness with respect to light having a wavelength of 460 nm of 89% or more, a curved surface portion having a curvature radius of 10000 mm or less in at least a part of a peripheral portion, and a thickness deviation of 1% or less of a maximum thickness.

The method for manufacturing a glass having a curved surface portion of the present disclosure comprises: heating a glass base plate; applying an external force to the heated glass base plate to form the curved surface portion having a curvature radius of 10000 mm or less in at least a part of a peripheral portion of the glass base plate; and obtaining the glass wherein a refractive index n_{d} is 1.77 or more, an internal transmittance of a thickness of 10 mm with respect to light having a wavelength of 460 nm is 89% or more, and a thickness deviation is 1% or less of a maximum thickness.

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a glass according to the present embodiment;

FIG. 2 is a schematic diagram illustrating an application example of the glass to a head mounted display;

FIG. 3 is a schematic plan view of the glass according to the present embodiment;

FIG. 4 is a graph illustrating viscosity changes of a glass material X and a glass material Y used in Examples with respect to temperature; and

FIG. 5 is a view for explaining the method for manufacturing the glass according to the present embodiment.

### DETAILED DESCRIPTION OF THE PREFERRED EMBODIMENTS

Hereinafter, preferred embodiments of the present invention will be described in detail with reference to the accompanying drawings. Note that the present invention is not limited by the embodiments, and in a case where there are a plurality of embodiments, the present invention includes a combination of the embodiments. The numerical value includes a range of rounding.

### Glass

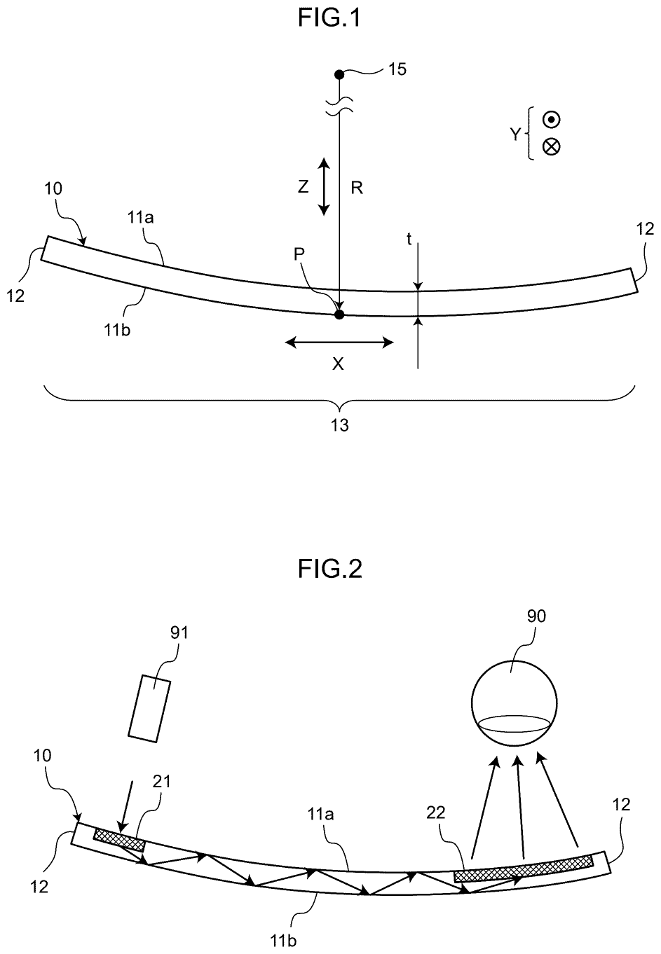

FIG. 1 is a schematic diagram of the glass according to the present embodiment. A glass 10 according to the present embodiment is a translucent member capable of transmitting visible light. The glass 10 according to the present embodiment is a plate-like member. In the present embodiment, the glass 10 is used as a light guide plate. The glass 10 is used as a light guide plate for an AR/MR head mounted display. The head mounted display is a display device (wearable device) mounted on a human head. However, the application of the glass 10 is arbitrary, and is not limited to being used as a light guide plate, and is not limited to being used for a head mounted display.

FIG. 2 is a schematic diagram illustrating an application example of the glass 10 to a head mounted display. The glass 10 is used for, for example, a transmissive head mounted display. The glass 10 is applied to a lens portion of the spectacle type device, a visor shield portion of the helmet type device, and the like, and is disposed in front of an eye 90 of a wearer. The glass 10 allows the wearer to visually recognize a scene in the visual field through the glass 10. In the example of FIG. 2, the glass 10 is provided with an incidence unit 21 on which a display image (incident light) is incident from a projection device 91, and an emission unit 22 that emits the display image to the eye 90 of the wearer. The incidence unit 21 and the emission unit 22 are, for example, diffraction gratings. The glass 10 repeatedly specularly reflects incident light inside the glass 10 (between both main surfaces 11a and 11b) to propagate the display image from the incidence unit 21 toward the emission unit 22. The glass 10 projects the display image onto the eye 90 of the wearer by emitting the display image from the emission unit 22. Accordingly, the wearer visually recognizes the display image by superimposing the display image on the scene in the visual field (the scene in front viewed through the glass 10). The configuration illustrated in FIG. 2 is merely an example, the glass 10 may be applied to any type of head mounted display, and an image display method using the glass 10 is not particularly limited. The incidence unit 21 and the emission unit 22 may be provided at any position of the glass 10, and the incidence unit 21 and the emission unit 22 may not be diffraction gratings.

### Structure of Glass

As illustrated in FIG. 1, the glass 10 has a pair of the main surfaces 11a and 11b and an end face 12. The pair of main surfaces 11a and 11b are surfaces having the largest area of the glass 10, and face each other in the thickness direction of the glass 10. The end face 12 is a peripheral surface that connects outer peripheral edges of the pair of main surfaces 11a and 11b. The glass 10 has a thickness t. The outer shape (shape of main surfaces 11a and 11b) of the glass 10 is not particularly limited, and depends on the device to which the glass 10 is applied. For example, when the glass 10 is applied to a spectacle type device, the shapes of the main surfaces 11a and 11b are shapes corresponding to lens portions of the spectacles.

Hereinafter, a thickness direction of the glass 10 is defined as a Z direction, one direction orthogonal to the Z direction is defined as an X direction, and a direction orthogonal to the Z direction and the X direction is defined as a Y direction. Note that the Z direction may be a direction perpendicular to the principal surface of the glass 10 at the center position of the principal surface. Here, the X direction refers to a direction in which a curvature radius of a line formed by intersecting a plane including the tangential direction and the normal direction and the main surface 11a is minimized among tangential directions of the main surface 11a at an arbitrary point P of the main surface 11a of the glass 10. In the example of the present embodiment, the incidence unit 21 and the emission unit 22 are disposed side by side in the X direction.

### Curved Surface Portion

The glass 10 according to the present embodiment has a curved surface portion 13 in at least a part of the peripheral portion. The curved surface portion 13 is bent with the Y axis as a bending axis. The curved surface portion 13 is a region of the glass 10 that is bent with the same curvature radius R with the Y direction as a bending axis. Here, the fact that the curvature radii R are the same is not limited to the fact that the curvature radii R at the respective positions are exactly the same. The curvature radius R of the curved surface portion 13 may change within a predetermined range for each position in the curved surface portion 13 as described later.

In the example of FIG. 1, the entire glass 10 is uniaxially bent at a curvature center 15 and a curvature radius R. Since the entire glass 10 is bent in the X direction with the curvature radius R, the entire glass 10 is the curved surface portion 13. Therefore, in the example of FIG. 1, the X direction is uniquely determined for any point of a position P. However, a plurality of curved surface portions 13 may be provided, and bending directions of the curved surface portions 13 may intersect each other. In this case, the X direction may be defined for each curved surface portion 13. That is, in the tangential direction at the position P on one curved surface portion 13, the direction in which the curvature radius of the line formed by intersecting the plane including the tangential direction and the normal direction and the main surface 11a is minimized may be defined as the X direction of the curved surface portion 13, and the X direction may be similarly defined for each curved surface portion 13. When there is a plurality of tangential directions in which the curvature radius of the line formed by intersecting the main surface 11a with the plane including the tangential direction and the normal direction is minimized, at least one of the tangential directions may be determined as the X direction.

In the examples of FIGS. 1 and 2, the glass 10 has a curved shape in the image propagation direction (X direction) connecting incidence unit 21 (see FIG. 2) and the emission unit 22 (see FIG. 2) by the curved surface portion 13. Accordingly, the viewing angle (FOV) of the emission unit 22 becomes larger than that of the flat plate shape. In one example, the glass 10 forms a three-dimensional curved surface at the curved surface portion 13. That is, the Gaussian curvature of the curved surface portion 13 may be non-0. In the example of FIG. 1, almost the entire glass 10 is the curved surface portion 13, but the curved surface portion 13 may be provided only in a part of the peripheral portion of the glass 10, and the other portion may have a planar shape.

### Curvature Radius of Curved Surface Portion

In the present embodiment, the curvature radius R of the curved surface portion 13 is 10000 mm or less. Accordingly, the viewing angle of the head mounted display can be widened as compared with the case of the flat plate shape. The curvature radius R of the curved surface portion 13 is preferably 10 mm or more and 1000 mm or less, more preferably 50 mm or more and 500 mm or less, and still more preferably 80 mm or more and 200 mm or less. The curvature radius R of the curved surface portion 13 can be acquired, for example, by acquiring a cross-sectional profile (distribution of the positions (displacements) of the main surfaces 11a and 11b along the cross-section) of a neighboring region including the curved surface portion 13 and approximating the cross-sectional profile to a circle by a least squares method. The cross-sectional profile is obtained by measuring the distribution of the positions (displacements) of the main surfaces 11a and 11b along the cross-section with a multi-color confocal laser displacement meter (manufactured by KEYENCE CORPORATION).

### Rate of Change of Curvature Radius

The glass 10 preferably has a rate of change (rate of change of curvature radius) of the curvature radius R in the curved surface portion 13 with respect to the average value of 200% or less and 70% or more. Here, the rate of change of curvature radius R is a ratio of the measured value of the curvature radius R at the measurement position to the average value of the curvature radius R of the entire curved surface portion 13. When the rate of change of curvature radius is in this range, high shape accuracy can be obtained, so that image quality can be improved and chromatic aberration can be reduced. The rate of change of curvature radius is more preferably 195% or less, 75% or more, still more preferably 190% or less, 80% or more. In the acquisition of the rate of change in the curvature radius R, first, a cross-sectional profile of a neighboring region including the curved surface portion 13 is divided by a unit length, and position measurement values of a plurality of measurement points in the division are acquired. The unit length is, for example, a predetermined value (for example, 5 mm) of 1 mm or more and 10 mm or less. The pitch of the measurement points in the divisions is, for example, 25 μm. The curvature radius R for each division is obtained by approximating the measured values in the divisions by the least squares method. The rate of change in the curvature radius R is expressed as a percentage obtained by dividing the curvature radius R of each division by the average value of the curvature radii R of all divisions.

### Area of Glass

In the glass 10, the main surfaces 11a and 11b preferably have an area of 40 cm² or less. The glass 10 is formed such that each of the main surfaces 11a and 11b falls within this range. Since an excessively large area causes deterioration in shape accuracy, the glass 10 having a surface area in this range is suitable as a display unit of a head mounted display, and uniformity of optical characteristics can be easily secured. The areas of the main surfaces 11a and 11b are more preferably 15 cm² or more and 35 cm² or less, still more preferably 10 cm² or more and 30 cm² or less.

### Thickness

The thickness t of the glass 10 according to the present embodiment is preferably 1.5 mm or less. As the thickness t increases, a shape error easily occurs, so that the glass 10 having the thickness t in this range can obtain high shape accuracy. The thickness t is more preferably 0.3 mm or more and 1.4 mm or less, still more preferably 0.5 mm or more and 1.2 mm or less.

The thickness t is measured by acquiring the axial positions of the main surface 11a and the main surface 11b at a measurement point of the glass 10 with a multi-color confocal laser displacement meter (manufactured by KEYENCE CORPORATION) in which the optical axis is aligned with the vertical direction and the measurement direction is aligned. The thickness t at the measurement point is acquired from a difference between the position measurement value of the main surface 11a and the position measurement value of the main surface 11b. During the measurement, the glass 10 is held such that at least one of the main surfaces 11a and 11b is orthogonal to the sensor optical axis.

### Thickness Deviation

The glass 10 according to the present embodiment has a thickness deviation of 1% or less of the maximum thickness. For example, when the thickness t of the glass 10 is 1 mm, the thickness deviation is 10 μm (that is, ±5 μm) or less. In the glass 10 having the thickness deviation in this range, high shape uniformity can be obtained even in the curved surface portion 13, so that image quality can be improved and chromatic aberration can be effectively reduced. The thickness deviation of the glass 10 is more preferably 0.8% or less of the maximum thickness, still more preferably 0.7% or less of the maximum thickness, and still more preferably 0.6% or less of the maximum thickness. The thickness deviation is a difference between the maximum value and the minimum value of the thickness t at each measurement point of the glass 10. The measurement points are set at a constant pitch along the bending direction of the glass 10 (along a cross section in which the main surfaces 11a and 11b are curved). The pitch of the measurement points is, for example, 130 μm.

### Flat Portion

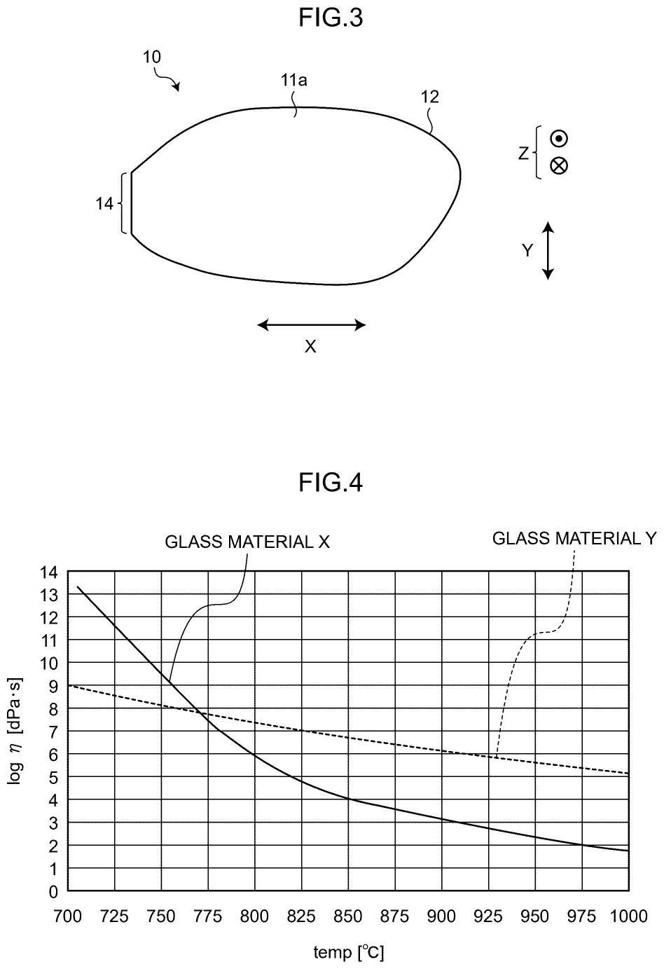

The glass 10 according to the present embodiment preferably has one or more flat portions 14 (see FIG. 3) on the outer peripheries of the main surfaces 11a and 11b. FIG. 3 is a schematic plan view of the glass 10 according to the present embodiment. The flat portion 14 is a region whose cross section is a straight line (a normal line of each point is parallel) over a range from one end portion to the other end portion of the flat portion 14. In the example of FIG. 3, the flat portion 14 is formed at one place of the end face 12 constituting the outer peripheries of the main surfaces 11a and 11b. The flat portion 14 is locally formed in a predetermined range of the outer peripheries of the main surfaces 11a and 11b. The flat portion 14 may be formed in a continuous annular shape over the entire circumference of the main surfaces 11a and 11b.

The glass 10 having the flat portion 14 on the outer periphery can cause the flat portion 14 to function as a reference surface for positioning or a gripping (supporting) surface. Therefore, for example, as compared with a case where the flat portion 14 is not provided and the entire outer periphery is a curved surface, the positional accuracy of the glass 10 when holding the glass 10 in processing, inspection, and assembly of the glass 10 is improved.

### End Face

In the glass 10 according to the present embodiment, the surface roughness Ra of the end face 12 is preferably 5 nm or more. Since the end face 12 has the surface roughness in this range, the light on the end face 12 can be diffusely reflected. As a result, it is possible to suppress optical noise such as bright lines caused by specular reflection of light (see FIG. 2) guided in the glass 10 on the end face 12, and thus, it is possible to improve image quality. Ra of the end face 12 is more preferably 10 nm or more, and still more preferably 20 nm or more. Here, the surface roughness Ra is an arithmetic average roughness defined in JIS B0601 (2001). In the present specification, an area of 10 μm×10 μm is a value measured using a laser microscope.

The end face 12 of the glass 10 is preferably painted black. Since the end face 12 is painted black having a high light absorption rate, reflection of light on the end face 12 can be suppressed. Accordingly, it is possible to suppress optical noise such as bright lines caused by specular reflection of light guided in the glass 10 on the end face 12, and thus, it is possible to improve image quality.

### Characteristics of Glass

Next, characteristics of the glass 10 will be described.

### Refractive Index

The glass 10 according to the present embodiment has a refractive index n_{d} of 1.77 or more. By having a high refractive index n_{d} in this range, the viewing angle in the head mounted display can be effectively expanded. The refractive index n_{d} of the glass 10 is preferably 1.80 or more, more preferably 1.85 or more, more preferably 1.88 or more, and still more preferably 1.90 or more. Accordingly, the viewing angle can be more effectively expanded. The refractive index n_{d} of the glass 10 is more preferably 1.94 or more, still more preferably 1.97 or more, still more preferably 1.99 or more, still more preferably 2.00 or more, still more preferably 2.05 or more, and still more preferably 2.10 or more. The refractive index can be measured by spectroscopic ellipsometry (J. A. Woollam Co., Inc.; M-2000 DI).

### Internal Transmittance

The glass 10 according to the present embodiment has an internal transmittance of 89% or more with respect to light having a wavelength of 460 nm at a thickness of 10 mm. When the internal transmittance of the glass 10 is in this range, high transmittance with respect to visible light can be realized, and light amount loss associated with light guiding can be reduced, so that image quality is improved. The internal transmittance of the glass 10 in the thickness direction with respect to light having a wavelength of 460 nm is more preferably 90% or more, further preferably 91.5% or more, further preferably 93.0% or more, and further preferably 95.0% or more.

The internal transmittance of the glass 10 is a transmittance that passes through the inside of the glass 10 to be measured. The internal transmittance can be obtained from measured values of two types of external transmittances having different plate thicknesses and the following formula (1). The external transmittance means transmittance including surface reflection loss. In the formula (1), X is an internal transmittance of a glass having a thickness of 10 mm, T1 and T2 are external transmittances, and Δdmm is a difference in thickness of the sample. The external transmittance can be measured using a spectrophotometer (U-4100 manufactured by Hitachi High-Technologies Corporation) on a sample whose both surfaces have been mirror-polished.

$$log X = - \frac{log T 1 - log T 2}{Δ d} \times 10 \qquad ( 1 )$$

### Retardation

The glass 10 according to the present embodiment preferably has a retardation of 40 nm/cm or less as measured by irradiating the glass with light having a wavelength of 543 nm in the thickness direction. By setting the retardation within this range, image distortion caused by the retardation can be suppressed, so that image quality can be improved. The retardation is more preferably 20 nm/cm or less, more preferably 18 nm/cm or less, still more preferably 15 nm/cm or less. The retardation can be measured by WPA-200 manufactured by Photonic Lattice.

### Wavefront Aberration

The glass 10 according to the present embodiment preferably has a PV value (peak-to-valley) of wavefront aberration of the main surfaces 11a and 11b measured with a laser interferometer of 1.6λ or less. λ represents the wavelength of the laser of the laser interferometer. The Root Mean Square value (RMS value) of the wavefront aberration indicating the variation of the main surfaces 11a and 11b from the reference wavefront is preferably 0.7λ or less. It is more preferably 0.5λ or less, more preferably 0.25λ or less, and still more preferably 0.1λ or less. By setting the wavefront aberrations of the main surfaces 11a and 11b within these ranges, it is possible to suppress blurring and distortion of the display image caused by the wavefront aberration, so that the image quality can be improved. The wavefront aberration can be measured by Verifire manufactured by Zygo.

### Composition of Glass

Next, an embodiment of a composition range of each component that can be contained in the glass 10 will be described in detail. In the present specification, the content ratio of each component is represented by mass % based on oxide unless otherwise specified. In addition, in the present specification, “not substantially contain” means not to contain, except for inevitable impurities. The content ratio of the inevitable impurities is 0.1% or less in the present specification. The glass is not limited to the composition of the following embodiment as long as the glass has the characteristics described above.

SiO₂ is a glass-forming component, and is a component that imparts high strength and crack resistance to glass and improves stability and chemical durability of glass. The content ratio of SiO₂ may be 0% or more and 44% or less. The content ratio of SiO₂ is preferably 3% or more, more preferably 5% or more, further preferably 7% or more, further preferably 9% or more, further preferably 10% or more, and particularly preferably 11% or more. On the other hand, when the content ratio of SiO₂ is 44% or less, more components for obtaining a high refractive index can be contained. The content ratio of SiO₂ is more preferably 38% or less, more preferably 30% or less, still more preferably 20% or less, still more preferably 15% or less, still more preferably 12% or less, particularly preferably 10% or less.

Al₂O₃ is a component that improves chemical durability, but when Al₂O₃ is increased, the glass is easily devitrified. Therefore, the content ratio of Al₂O₃ can be 0% or more and 5% or less. The content ratio of Al₂O₃ is more preferably 3% or less, and particularly preferably 2% or less. In addition, the content ratio of Al₂O₃ is more preferably 0.3% or more, still more preferably 0.5% or more, and particularly preferably 1% or more.

P₂O₅ is a component that improves solubility of glass and enhances manufacturability. The content ratio of P₂O₅ is preferably more than 0%, more preferably more than 2.0%, more preferably more than 4.0%, still more preferably more than 6.0%, and still more preferably more than 8.0%. The content ratio of P₂O₅ is preferably less than 18.0%, more preferably less than 16.0%, still more preferably less than 14.0%, and still more preferably less than 12.0%. When the content ratio of P₂O₅ is less than 18.0%, a high refractive index is obtained, which is preferable.

B₂O₃ is a component that lowers Tg, improves mechanical properties such as glass strength and crack resistance, and lowers the devitrification temperature, but when the amount of B₂O₃ is large, the refractive index tends to decrease. Therefore, the content ratio of B₂O₃ may be 0% or more and 40% or less. The content ratio of B₂O₃ is more preferably 35% or less, still more preferably 30% or less, still more preferably 25% or less, still more preferably 20% or less, still more preferably 15% or less, particularly preferably 10% or less. The content ratio of B₂O₃ is more preferably 5% or more, still more preferably 12% or more, still more preferably 18% or more, particularly preferably 20% or more.

When the content ratio of SiO₂ and B₂O₃ is large, the devitrification temperature of glass is lowered, and glass is easily manufactured. Therefore, the content ratio of SiO₂ and B₂O₃ is preferably 10% or more, more preferably 20% or more, more preferably 25% or more, more preferably 28% or more, still more preferably 30% or more, particularly preferably 32% or more. On the other hand, when the content ratio of SiO₂ and B₂O₃ is reduced, the refractive index can be improved. Therefore, when a particularly high refractive index is required, the content ratio of SiO₂ and B₂O₃ is preferably 70% or less, more preferably 50% or less, still more preferably 40% or less, still more preferably 35% or less, still more preferably 33% or less, and particularly preferably 32% or less.

Li₂O is a component that improves strength and crack resistance. The content ratio of Li₂O may be 0% or more and 10% or less. The content ratio of Li₂O is preferably 0% or more, more preferably 1% or more, more preferably 2% or more, still more preferably 4% or more, particularly preferably 5% or more. On the other hand, when the amount of Li₂O is too large, the glass is easily devitrified. In particular, when quality with respect to devitrification is required, the content ratio of Li₂O is preferably 8% or less, more preferably 6% or less, still more preferably 4% or less, still more preferably 2% or less, particularly preferably 1% or less.

Na₂O is a component that suppresses devitrification and lowers Tg. The content ratio of Na₂O may be 0% or more and 10% or less. When Na₂O is contained, an excellent devitrification suppressing effect is obtained. When the glass contains Na₂O, the content ratio thereof is preferably 0% or more, more preferably 1% or more, more preferably 2% or more, still more preferably 3% or more, particularly preferably 4% or more. On the other hand, when the content of Na₂O is too large, strength and crack resistance are likely to decrease. In particular, when strength is required, the content ratio of Na₂O is preferably 7% or less, more preferably 4% or less, still more preferably 2% or less, particularly preferably 1% or less.

K₂O is a component that suppresses devitrification and lowers Tg. The content ratio of K₂O may be 0% or more and 10% or less. The content ratio of K₂O is preferably 0% or more, more preferably 1% or more, more preferably 2% or more, still more preferably 3% or more, particularly preferably 4% or more. On the other hand, when the amount of K₂O is too large, the strength and the crack resistance tend to decrease. In particular, when strength is required, the content ratio of K₂O is preferably 7% or less, more preferably 4% or less, still more preferably 2% or less, particularly preferably 1% or less.

ZrO₂ is a component that increases the refractive index of glass and increases the chemical durability of glass. The content ratio of ZrO₂ may be 0% or more and 20% or less. The content ratio of ZrO₂ is preferably 1% or more, more preferably 3% or more, still more preferably 5% or more, still more preferably 6% or more, particularly preferably 6.5% or more. On the other hand, when the amount of ZrO₂ is too large, devitrification is likely to occur. Therefore, the content ratio of ZrO₂ is more preferably 15% or less, still more preferably 10% or less, still more preferably 8% or less, and particularly preferably 7% or less.

Furthermore, the glass may contain at least one of Sb₂O₃ and SnO₂. These are not essential components, but can be added for the purpose of adjustment of refractive index characteristics, improvement of meltability, suppression of coloring, improvement of transmittance, clarification, improvement of chemical durability, and the like. The content ratio in the case of containing these components is preferably 10% or less, more preferably 5% or less, still more preferably 3% or less, and particularly preferably 1% or less in total.

Y₂O₃ is a component that increases the refractive index of glass. The content ratio of Y₂O₃ may be 0% or more and 10% or less. The content ratio of Y₂O₃ is preferably 1% or more, more preferably 1.5% or more, further preferably 2% or more, further preferably 2.5% or more, further preferably 3% or more, further preferably 3.5% or more, further preferably 4% or more, and particularly preferably 5% or more. In addition, when Y₂O₃ is too large, the glass is easily devitrified. Therefore, for applications requiring lower surface roughness Ra, the content ratio of Y₂O₃ is preferably 10% or less, more preferably 7% or less, more preferably 5% or less, more preferably 4% or less, still more preferably 3.5% or less, and particularly preferably 3% or less.

When the combined amount of the alkali metal component (Li₂O+Na₂O+K₂O) and the alkaline earth metal component (MgO+CaO+SrO+BaO) increases, the Tg of glass tends to decrease. Therefore, the content ratio of the alkali metal component and the alkaline earth metal component can be 50% or less. The content ratio is more preferably 40% or less, further preferably 30% or less, further preferably 16% or less, further preferably 12% or less, further preferably 10% or less, further preferably 5% or less, and particularly preferably 2% or less.

TiO₂ is a component that increases the refractive index of glass and increases the dispersion of glass. The content ratio of TiO₂ may be 0% or more and 50% or less. When TiO₂ is contained, the content ratio thereof is preferably 3% or more, more preferably 5% or more, further preferably 10% or more, further preferably 15% or more, further preferably 20% or more, further preferably 25% or more, further preferably 28% or more, further preferably 30% or more, and particularly preferably 32% or more. On the other hand, when the amount of TiO₂ is too large, coloring easily occurs, and the transmittance decreases. Therefore, in particular, when the transmittance is required, the content ratio of TiO₂ is preferably 50% or less, more preferably 40% or less, still more preferably 35% or less, still more preferably 30% or less, still more preferably 25% or less, still more preferably 20% or less, and particularly preferably 15% or less.

The addition of WO₃ suppresses devitrification of glass, but when the addition amount is too large, the glass is rather easily devitrified. Therefore, the content ratio of WO₃ may be 0% or more and 10% or less. The content ratio of WO₃ is more preferably 6% or less, still more preferably 2% or less, still more preferably 1.5% or less, still more preferably 1.0% or less, still more preferably 0.5% or less, particularly preferably 0.3% or less. In addition, the refractive index of glass can be improved by adding WO₃. Therefore, when a particularly high refractive index is required, the content ratio of WO₃ is more preferably 0.1% or more, still more preferably 0.2% or more, still more preferably 0.3% or more, and particularly preferably 0.4% or more.

La₂O₃ is a component that improves the refractive index of glass. The content ratio of La₂O₃ may be 0% or more and 55% or less. When La₂O₃ is contained, the content ratio thereof is preferably 10% or more, more preferably 15% or more, further preferably 20% or more, further preferably 25% or more, further preferably 30% or more, and particularly preferably 40% or more. On the other hand, when the amount of La₂O₃ is too large, the mechanical properties are deteriorated and the devitrification temperature is increased. Therefore, when mechanical characteristics and manufacturing characteristics are important, the content ratio of La₂O₃ is preferably 53% or less. The content is more preferably 50% or less, more preferably 45% or less, particularly preferably 42% or less.

Nb₂O₅ is a component that increases the refractive index of glass and decreases the Abbe number (v_{d}). The content ratio of Nb₂O₅ may be 0% or more and 35% or less. The content ratio of Nb₂O₅ is preferably 2% or more, more preferably 4% or more, further preferably 5% or more, further preferably 6% or more, further preferably 7% or more, further preferably 8% or more, and particularly preferably 10% or more. In addition, when Nb₂O₅ is too large, the glass is easily devitrified. Therefore, for applications requiring lower surface roughness Ra, the surface roughness is preferably 20% or less, more preferably 15% or less, still more preferably 10% or less, still more preferably 8% or less, particularly preferably 7% or less.

### Method for Manufacturing Glass

The glass 10 according to the present embodiment may be manufactured by an arbitrary method, but an example of the manufacturing method will be described below.

### Preparation of Raw Material

As a raw material used for manufacturing the glass 10, raw materials are weighed so as to have a desired glass composition from the above composition range, and uniformly mixed.

### Manufacturing for Glass Base Plate

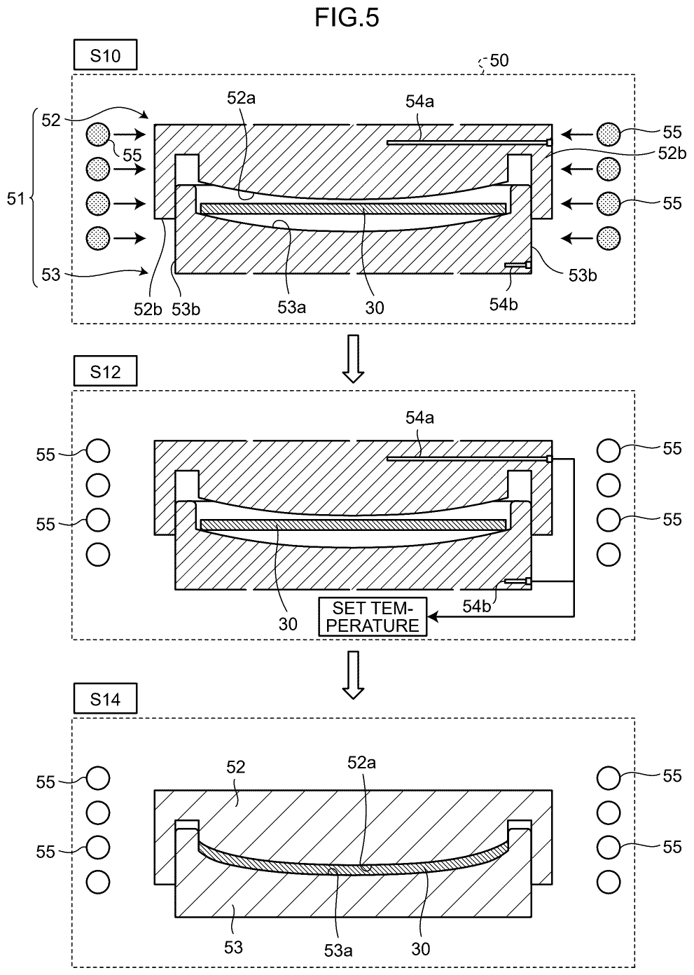

The glass raw material is made into a glass state through an arbitrary glass melting forming method such as float, fusion, ingot forming, and the like, and machining such as slicing if necessary, and a glass base plate 30 (see FIG. 5) having a desired composition is produced. In addition, the molten glass is once formed into a block shape, and then the glass base plate 30 can be formed by a drawing method or the like. The glass base plate 30 is plate-like glass serving as a base material of the glass 10. The glass base plate 30 has a refractive index n_{d} of 1.77 or more, and an internal transmittance of 89% or more for light with a wavelength of 460 nm at a thickness of 10 mm.

In the glass base plate 30 in the present embodiment, the temperature difference between the glass transition point Tg and the softening point is preferably 150° C. or less. The glass base plate 30 in which the temperature difference between the glass transition point Tg and the softening point is in this range can obtain a high refractive index n_{d} suitable for expanding the viewing angle of the head mounted display. The temperature difference between the glass transition point Tg and the softening point is more preferably 120° C. or less, and still more preferably 100° C. or less. The glass transition point Tg can be measured by, for example, a thermal expansion method. The softening point can be measured by a fiber stretching method described in JIS R3103-1:2001.

FIG. 4 is a graph illustrating viscosity changes with respect to temperature of the glass material X and the glass material Y used in Examples described later. The vertical axis of the graph represents viscosity log η (dPa·s), and the horizontal axis represents temperature (° C.). The refractive index n_{d} of the glass material X is higher than the refractive index n_{d} of the glass material Y. In the glass material Y, the viscosity log η changes from about 13.5 (dPa·s) to about 7.65 (dPa·s) in a temperature range (temperature difference of about 250° C.) of a glass transition point Tg (about 532° C.) or more and a softening point (about 782° C.) or less. On the other hand, in the glass material X, the viscosity log η changes from about 13.2 (dpa·s) to about 5.8 (dpa·s) in a temperature range (temperature difference of about 95° C.) of the glass transition point Tg (about 705° C.) or more and the softening point (about 800° C.) or less. As described above, in the glass material as a raw material of the glass 10, when the refractive index n_{d} increases, the temperature difference between the glass transition point Tg and the softening point decreases, and the change in viscosity with respect to the temperature change near the forming temperature tends to increase. Similarly, in a glass material A, a glass material B, and a glass material C used in Examples described later, the refractive index n_{d} of each of the glass material A, the glass material B, and the glass material C is higher than the refractive index n_{d} of the glass material Y (see Table 3). Therefore, in the glass material A, the glass material B, and the glass material C, the change in viscosity with respect to the temperature change from the glass transition point Tg to the softening point is larger than that of the glass material Y.

In a glass material whose viscosity greatly changes depending on the temperature, a variation in temperature distribution of the glass base plate 30 at the time of forming brings about a large variation in viscosity, and thus has a large influence on forming variations (variations such as thickness t, surface roughness Ra, retardation, and wavefront aberration). Therefore, in the manufacturing of the glass 10 having a high refractive index, it is important to uniformize the temperature distribution of the glass base plate 30 during forming.

Bending forming of glass base plate FIG. 5 is a view for explaining the method for manufacturing the glass 10 according to the present embodiment. The method for manufacturing the glass 10 according to the present embodiment heats the glass base plate 30 (step S10), applies an external force to the heated glass base plate 30, and forms the curved surface portion 13 having a curvature radius of 10000 mm or less in at least a part of the peripheral portion of the glass base plate 30 (step S14) to obtain the glass 10. That is, the method for manufacturing the glass 10 according to the present embodiment includes a reheat forming step (reheat bending forming step) of the glass base plate 30.

In the reheat bending forming step, heating and bending forming are preferably performed in a batch process by the batch forming apparatus 50. Accordingly, the forming temperature for each shot can be precisely controlled, and high shape accuracy can be obtained. For example, in the spectacle-type head mounted display, since the pair of glasses 10 for the left eye and the right eye is used as the light guide plate, the batch processing may be one-shot multiple sheet (for example, two sheets) forming or one-shot single sheet forming.

In FIG. 5, batch forming apparatus 50 includes a forming die 51 and a heater 55.

The forming die 51 includes a first die 52 and a second die 53 to which the first die 52 is fitted. In FIG. 5, the first die 52 is an upper die, and the second die 53 is a lower die. The first die 52 has a forming surface 52a and a peripheral wall 52b surrounding the outer periphery of the forming surface 52a. The forming surface 52a is a convex curved surface corresponding to the main surface 11a (see FIG. 1) of the glass 10. The second die 53 has a forming surface 53a and a peripheral side surface 53b. The forming surface 53a is a concave curved surface corresponding to the main surface 11b of the glass 10 (see FIG. 1). That is, the forming surface 52a and the forming surface 53a include a curved surface portion for forming the curved surface portion 13 on at least a part of the peripheral portion of the glass base plate 30.

The peripheral wall 52b of the first die 52 constitutes an opening corresponding to the outer shape of the second die 53. The peripheral side surface 53b of the second die 53 has the outer shape of the second die 53 and is fitted to the inner periphery of the peripheral wall 52b. Both the first die 52 and the second die 53 have sensor holding holes, and temperature sensors 54a and 54b are attached thereto, respectively. The first die 52 and the second die 53 are held so as to be relatively movable in directions of approaching and separating from each other. For example, the first die 52 as the upper die and the second die 53 as the lower die are movable in the vertical direction by a drive source (Cylinder, motor, etc.) not illustrated.

The heater 55 heats the glass base plate 30 together with the forming die 51 by radiation heating. The heater 55 is, for example, an infrared lamp heater, and various known heaters such as a carbon lamp and a halogen lamp can be used. The heater 55 is provided so as to surround the periphery of the forming die 51. A plurality of heaters 55 may be disposed in the height direction of the forming die 51 in order to uniformly heat the forming die 51. In step S10 of heating the glass base plate 30, the heater 55 heats the glass base plate 30 to a set temperature.

### Step of Heating Glass Base Plate

In the present embodiment, in step S10 of heating the glass base plate 30, it is preferable to heat the glass base plate 30 together with the forming die 51 by radiation heating from the heater 55 disposed around the forming die 51 in a state where the glass base plate 30 is disposed in the forming die 51. Accordingly, since the entire forming die 51 can be uniformly heated by radiation, temperature variations of the glass base plate 30 and the forming die 51 can be effectively reduced. In FIG. 5, radiation heat is indicated by arrows extending from the heater 55. The temperature difference between the set temperature of the heater 55 and the forming die 51 measured by the temperature sensors 54a and 54b is preferably ±3° C. or less, more preferably ±2° C. or less, and still more preferably ±1° C. or less.

Furthermore, in the present embodiment, it is preferable to heat the glass base plate 30 at a temperature rise rate of 50° C./min or less when heating (step S10). That is, it is preferable that the temperature rise per unit time (minute) falls within this range over the entire period from the start of heating to the end of heating. When the temperature rise rate is within this range, it is possible to suppress temperature variations of the forming die 51 and the glass base plate 30 inside. In particular, in the forming die 51 having the fitting structure as illustrated in FIG. 5, the first die 52 is likely to rise in temperature earlier than the second die 53 partially covered by the peripheral wall 52b, and thus the temperature difference can be reduced by lowering the temperature rise rate. The temperature rise rate is more preferably 45° C./min or less, still more preferably 40° C./min or less, and still more preferably 35° C./min or less. As the temperature rise rate is lowered, the temperature variation can be reduced.

### Step of Stopping Heating

In the present embodiment, it is preferable that the temperature of the forming die 51 is monitored, and heating is stopped based on the fact that the temperature has reached the set temperature (step S12). That is, based on the detected temperature values of the temperature sensors 54a and 54b, heating is stopped when all the detected temperature values reach the set temperature. Accordingly, since the temperature of the forming die 51 can be reliably set to the set temperature, temperature variation of the forming die 51 and the glass base plate 30 inside can be effectively suppressed. The set temperature is, for example, equal to or higher than the glass transition point Tg and equal to or lower than the softening point, and an appropriate value is set according to the glass composition.

When the heating is stopped (step S12), the temperature difference between the first die 52 and the second die 53 when the set temperature is reached is preferably 60° C. or less. By setting the temperature difference between the first die 52 and the second die 53 within this range, it is possible to more effectively suppress the temperature variation of the glass base plate 30. The temperature difference between the first die 52 and the second die 53 when the set temperature is reached is more preferably 55° C. or less, still more preferably 50° C. or less.

### Step of Forming Curved Surface Portion

In step S14 of forming the curved surface portion 13, press forming of pressurizing the heated glass base plate 30 with a forming die 51 is performed. That is, the glass base plate 30 disposed between the first die 52 and the second die 53 is pressurized by relatively moving the first die 52 in a direction approaching the second die 53. In FIG. 5, the convex forming surface 52a of the first die 52 presses the glass base plate 30 downward to deform the glass base plate 30. The forming die 51 deforms the glass base plate 30 by pressurization to bring both surfaces of the glass base plate 30 into close contact with the forming surface 52a of the first die 52 and the forming surface 53a of the second die 53, respectively. Accordingly, the curved surface shape of the forming surface 52a is transferred to one surface of the glass base plate 30 to form the main surface 11a. The curved surface shape of the forming surface 53a is transferred to the other surface of the glass base plate 30 to form the main surface 11b. The forming surface 52a and the forming surface 53a approach each other to a distance corresponding to the thickness t of the glass 10. As a result, the glass 10 having the curved surface portion 13 and the thickness t is formed.

Step S14 of forming the curved surface portion 13 ends when a predetermined time elapses after the pressurizing force reaches a predetermined set value. The predetermined time is, for example, 30 seconds. Upon completion of step S14 of forming the curved surface portion 13, the first die 52 and the second die 53 are relatively moved to the retraction position in a direction away from each other to separate the forming die 51. Thereafter, the glass 10 held by the second die 53 is cooled.

### Post-Processing Step

Thereafter, post-processing may be performed on the glass 10. Specifically, the flat portion 14 may be formed on a part of the outer periphery of the glass 10. A method for forming the flat portion 14 includes, for example, a polishing process. Roughening process for setting the surface roughness Ra of the end face 12 of the glass 10 to a set value of 5 nm or more may be performed. As a method of the roughening process, there is a blasting process such as sandblasting. Furthermore, black coating may be applied to the roughened end face 12. In addition, a surface film may be formed on the main surfaces 11a and 11b of the glass 10.

As described above, in the method for manufacturing the glass 10 according to the present embodiment, the glass 10 is manufactured in which the refractive index n_{d} is 1.77 or more, the internal transmittance of a thickness of 10 mm with respect to light having a wavelength of 460 nm is 89% or more, and the thickness deviation is 1% or less of the maximum thickness.

### Effects

As described above, a glass 10 according to the first aspect of the present disclosure has a refractive index n_{d} of 1.77 or more, an internal transmittance of 10 mm in thickness with respect to light having a wavelength of 460 nm of 89% or more, a curved surface portion 13 having a curvature radius of 10000 mm or less in at least a part of a peripheral portion, and a thickness deviation of 1% or less of a maximum thickness. According to the present disclosure, it is possible to obtain glass 10 having a high refractive index suitable for viewing angle enlargement in a head mounted display and a high transmittance that realizes a low optical loss suitable for image display. When the thickness deviation falls within 1% or less of the maximum thickness, variation in thickness distribution can be suppressed. As a result, even when the curved surface portion 13 is formed on the glass 10 having a high refractive index, deterioration of optical characteristics can be suppressed.

A glass 10 according to a second aspect of the present disclosure is the glass 10 according to the first aspect, and preferably has a refractive index n_{d} of 1.90 or more. According to the present disclosure, it is possible to obtain the glass 10 having a high refractive index n_{d} capable of effectively expanding the viewing angle when applied to an optical system such as a head mounted display.

A glass 10 according to a third aspect of the present disclosure is the glass 10 according to the first aspect or the second aspect, and preferably has a retardation of 40 nm/cm or less as measured by irradiating the glass with light having a wavelength of 543 nm in the thickness direction. According to the present disclosure, when the glass 10 is applied to an optical system such as a head mounted display, it is possible to suppress distortion of a display image caused by retardation.

A glass 10 according to a fourth aspect of the present disclosure is the glass 10 according to any one of the first to third aspects, in which an RMS value of wavefront aberration of a main surface measured with a laser interferometer is preferably 0.7λ or less. According to the present disclosure, when the glass 10 is applied to an optical system such as a head mounted display, blurring and distortion of a display image caused by wavefront aberration can be suppressed.

A glass 10 according to a fifth aspect of the present disclosure is the glass 10 according to any one of the first to fourth aspects, and preferably has one or more flat portions 14 on the outer periphery of the main surface. According to the present disclosure, the flat portion 14 can function as a reference surface or a gripping surface for positioning. Accordingly, for example, as compared with a case where the flat portion 14 is not provided and the entire outer periphery is a curved surface, the positional accuracy of the glass 10 when holding the glass 10 in processing, inspection, and assembly of the glass 10 is improved.

A glass 10 according to a sixth aspect of the present disclosure is the glass 10 according to any one of the first to fifth aspects, and the surface roughness Ra of the end face 12 is preferably 5 nm or more. According to the present disclosure, light on the end face 12 can be diffusely reflected. As a result, when the glass 10 is used as the light guide plate, it is possible to suppress light noise such as a bright line caused by regular reflection of light guided in the glass 10 on the end face 12.

A glass 10 according to a seventh aspect of the present disclosure is the glass 10 according to any one of the first to sixth aspects, and the end face 12 is preferably painted black. According to the present disclosure, reflection of light on the end face 12 can be suppressed by increasing the light absorption rate of the end face 12. Accordingly, when the glass 10 is used as the light guide plate, it is possible to suppress light noise such as a bright line caused by regular reflection of light guided in the glass 10 on the end face 12.

A glass 10 according to an eighth aspect of the present disclosure is the glass 10 according to any one of the first to seventh aspects, and main surfaces 11a and 11b preferably have an area of 40 cm² or less. According to the present disclosure, the glass 10 having a size suitable for application to a head mounted display is obtained. In addition, since the area of the glass 10 does not become excessively large, it is possible to easily and effectively suppress the shape variation of the glass 10.

A glass 10 according to a ninth aspect of the present disclosure is the glass 10 according to any one of the first to eighth aspects, and preferably has a thickness t of 1.5 mm or less. According to the present disclosure, as the thickness t increases, a shape error is more likely to occur. Therefore, by setting the thickness t within this range, the glass 10 with high shape accuracy can be obtained.

A glass 10 according to a tenth aspect of the present disclosure is the glass 10 according to any one of the first to ninth aspects, in which the rate of change of the curvature radius R in the curved surface portion 13 with respect to the average value is preferably 200% or less and 70% or more. According to the present disclosure, since high shape accuracy can be obtained, the optical characteristics of the glass 10 can be effectively improved.

A method for manufacturing a glass according to an eleventh aspect of the present disclosure is a method for manufacturing a glass 10 having a curved surface portion 13, the method including: heating a glass base plate 30 (step S10); applying an external force to the heated glass base plate 30 to form the curved surface portion 13 having a curvature radius of 10000 mm or less in at least a part of a peripheral portion of the glass base plate 30 (step S14); and obtaining the glass 10 having a refractive index n_{d} of 1.77 or more, an internal transmittance of a thickness of 10 mm with respect to light having a wavelength of 460 nm of 89% or more, and a thickness deviation of 1% or less of a maximum thickness. According to the present disclosure, the glass 10 having a high refractive index suitable for viewing angle enlargement in a head mounted display and a high transmittance that realizes a low optical loss suitable for image display is obtained. When the thickness deviation falls within 1% or less of the maximum thickness, variation in thickness distribution can be suppressed. As a result, even when the curved surface portion 13 is formed on the glass 10 having a high refractive index, deterioration of optical characteristics can be suppressed.

A method for manufacturing a glass 10 according to a twelfth aspect of the present disclosure is the method for manufacturing the glass 10 according to the eleventh aspect, in which the temperature difference between the glass transition point Tg and the softening point of the glass base plate 30 is preferably 150° C. or less. According to the present disclosure, it is possible to obtain a high refractive index n_{d} suitable for expanding the viewing angle of the head mounted display. On the other hand, when the temperature change in viscosity is large, it is difficult to obtain shape accuracy. However, by suppressing the thickness deviation to 1% or less of the maximum thickness, even from the glass base plate 30 having a high refractive index n_{d} in which the change in viscosity is large, the glass 10 having high shape accuracy and uniformity capable of suppressing deterioration in optical characteristics can be obtained.

A method for manufacturing a glass 10 according to a thirteenth aspect of the present disclosure is the method for manufacturing the glass 10 according to the eleventh aspect or the twelfth aspect, in which when the glass base plate 30 is heated (step S10), the glass base plate 30 is preferably heated together with the forming die 51 by radiation heating from the heater 55 disposed around the forming die 51 in a state where the glass base plate 30 is disposed in the forming die 51. According to the present disclosure, temperature uniformity of the forming die 51 can be improved by radiation heating as compared with heating by contact heat transfer, and thus temperature variations of the glass base plate 30 and the forming die 51 can be effectively reduced. As a result of reducing the temperature variation, the viscosity variation of the glass base plate 30 is reduced, so that the shape accuracy and uniformity of the glass 10 can be effectively improved.

A method for manufacturing a glass 10 according to a fourteenth aspect of the present disclosure is the method for manufacturing the glass 10 according to the thirteenth aspect, and it is preferable that the temperature of the forming die 51 is monitored, and heating is stopped based on a fact that the temperature has reached a set temperature (step S12). According to the present disclosure, since the temperature of the forming die 51 can be reliably set to the set temperature, temperature variation of the forming die 51 and the glass base plate 30 inside can be effectively suppressed.

A method for manufacturing a glass 10 according to a fifteenth aspect of the present disclosure is the method for manufacturing the glass 10 according to the fourteenth aspect, in which the forming die 51 includes the first die 52 and the second die 53 into which the first die 52 is fitted, and when heating is stopped (step S12), a temperature difference between the first die 52 and the second die 53 when a set temperature is reached is preferably 60° C. or less. According to the present disclosure, by reducing the temperature difference between the first die 52 and the second die 53, it is possible to more effectively suppress the temperature variation of the glass base plate 30.

A method for manufacturing a glass 10 according to a sixteenth aspect of the present disclosure is the method for manufacturing the glass 10 according to any one of the eleventh to fifteenth aspects, and it is preferable to heat the glass base plate 30 at a temperature rise rate of 60° C./min or less when heating the glass base plate (step S10). According to the present disclosure, the temperature variation of the forming die 51 and the glass base plate 30 inside can be effectively suppressed by lowering the temperature rise rate.

A method for manufacturing the glass 10 according to a seventeenth embodiment of the present disclosure is the method for manufacturing the glass 10 according to any one of eleventh to sixteenth aspects, and it is preferable that reheat bending of the glass base plate 30 is performed by batch processing using a batch forming apparatus. According to the present disclosure, the forming temperature can be precisely controlled for each shot, and high shape accuracy can be obtained.

A method for manufacturing a glass 10 according to an eighteenth embodiment of the present disclosure is the method for manufacturing the glass 10 according to a seventeenth aspect, in which the batch forming apparatus includes the forming die 51 and the heater 55, a temperature sensor (54a, 54b) is inserted into the forming die 51, and a temperature difference of the forming die 51 with respect to a set temperature of the heater 55 during the press forming is preferably ±3 degrees or less. According to the present disclosure, it is possible to more effectively suppress temperature variations of the forming die 51 and the glass base plate 30.

### EXAMPLES

Next, examples will be described. The embodiment may be changed as long as the effect of the invention is obtained. Table 1 is a table illustrating the composition and physical properties of the glass base plate used for manufacturing the glass of each example.

TABLE 1

| | | Glass | Glass | Glass | Glass | Glass |
|---|---|---|---|---|---|---|
| | | material X | material Y | material A | material B | material C |
| | | (Example 1, | (Example 3, | (Example 5, | (Example 7, | (Example 9, |
| | | Example 2) | Example 4) | Example 6) | Example 8) | Example 10) |
| SiO₂ | | 6.0 | 69.6 | 7.19 | 15.12 | 8.78 |
| Al₂O₃ | | | 12.6 | 1.46 | 0.35 | |
| B₂O₃ | | 11.6 | | 9.38 | 4.77 | 12.53 |
| Li₂O | | | 4 | | | |
| Na₂O | | | 5.1 | | 4.07 | |
| K₂O | | | 1.6 | | 1.92 | |
| CaO | | | 0.5 | | 3.71 | |
| MgO | | | 4.6 | | | |
| ZrO₂ | | 5.0 | 2 | 3.5 | 5.42 | 5.99 |
| SnO₂ | | | | | | |
| Y₂O₃ | | 6.2 | | | | 8.18 |
| TiO₂ | | 13.1 | | 10.22 | 22.52 | |
| WO₃ | | 0.3 | | 0.68 | | |
| La₂O₃ | | 50.5 | | 38.36 | | 50.48 |
| Nb₂O₅ | | 7.3 | | 10.72 | 8.88 | 3.87 |
| BaO | | | | 14.42 | 33.24 | 0.47 |
| ZnO | | | | 4.08 | | |
| Gd₂O₃ | | | | | | 9.7 |
| Characteristics | ρ [g/cm³] | 4.81 | 2.45 | 4.66 | 3.9 | 4.57 |
| | Tg | 705 | 532 | 654 | 594 | 697 |
| | Softening | 800 | 782 | 763 | 718 | 785 |
| | point | | | | | |
| | E [GPa] | 134 | 84 | 112 | 98 | 120 |

### Example 1

In Example 1, a glass base plate having a composition shown in “glass material X” in Table 1 was produced. The glass base plate had a flat plate shape with a thickness of 1.0 mm, a width of 34 mm, and a length of 65 mm.

A convex die (first die) and a concave die (second die) made of carbon designed to be able to form glass having a design shape having a curvature radius of 150 mm, a bending depth of 5 mm, and a uniaxial bent bending surface in the long side direction were prepared, and a chamfered glass base plate was placed near the center of the concave die forming surface.

The glass base plate was heated, deformed, and cooled in a state where the concave die and the convex die on which the glass base plate was placed were fixed to the lower shaft and the upper shaft of the forming device (Glass element forming apparatus manufactured by SHIBAURA MACHINE CO., LTD. (former TOSHIBA MACHINE CO., LTD.): GMP-315V), respectively.

In the heating step, the set temperature was set to 710° C., and heating was stopped when each of the convex die and the concave die reached the set temperature. The temperature was raised from the starting temperature (25° C.) to the set temperature (710° C.) in 20 minutes. The temperature rise rate was controlled within a range of 50° C./min or less.

The concave die was moved upward and the convex die was pressed at a maximum of 0.5 kN. The pressurization was ended 30 seconds after the pressurizing force reached the set value (0.5 kN). During that time, a nitrogen gas of 20 L/min was blown from the through hole provided in the convex die so that the glass plate was uniformly formed.

Next, the mixture was slowly cooled to 100° C. over 28 minutes. Next, the concave die was lowered and retracted, and the glass base plate was allowed to cool to room temperature to obtain glass.

### Example 2

In Example 2, the same glass base plate (glass material X) as in Example 1 was formed by a different forming method. In Example 2, bending forming was performed by a continuous forming apparatus (SHENZHEN HUANQIUTONGCHUANG MACHINERY CO., LTD., JM2000) to obtain glass. In the continuous forming apparatus, a rod heater is built in each of a movable upper die plate that holds an upper surface of a convex die (upper die) and a lower die plate that holds a lower surface of a concave die (lower die), and the convex die and the concave die are heated by contact heat transfer from the heated upper die plate and lower die plate. The glass base plate installed in the concave die is heated by contact heat transfer via a contact portion with the heated concave die. The structures of the convex (upper die) and the concave (lower die) dies are the same as in Example 1.

The continuous forming apparatus comprises a chamber in which first to sixth preheating zones, first to third heating zones, first to third slow cooling zones, and first to fourth water cooling zones are provided from the inlet to the outlet. Each zone is provided with a stage that supports each of a convex die (upper die) and a concave die (lower die).

The temperature and applied pressure of the rod heater in each zone, and the total residence time in the chamber are as shown in Table 2 below.

TABLE 2

| | Set temperature of heater | | | | | | |
|---|---|---|---|---|---|---|---|
| | Upper [° C.]/Lower [° C.] | | | | | | Total time |
| | Glass | Glass | Glass | Glass | Glass | Applied | spent in |
| | material X | material Y | material A | material B | material C | pressure | chamber |
| | (Example 2) | (Example 4) | (Example 6) | (Example 8) | (Example 10) | [MPa] | [min] |
| First preheating zone | 470/470 | 410/470 | 480/540 | 460/460 | 550/550 | 0.2 | 2 |
| Second preheating zone | 550/550 | 450/510 | 520/580 | 500/500 | 590/590 | 0.2 | 4 |
| Third preheating zone | 620/620 | 530/590 | 600/660 | 580/580 | 670/670 | 0.2 | 6 |
| Fourth preheating zone | 680/680 | 590/650 | 660/720 | 640/640 | 730/730 | 0.2 | 8 |
| Fifth preheating zone | 740/740 | 620/680 | 690/750 | 660/660 | 750/750 | 0.2 | 10 |
| Sixth preheating zone | 780/780 | 640/700 | 710/770 | 680/680 | 770/770 | 0.2 | 12 |
| First heating zone | 770/770 | 620/680 | 690/750 | 670/670 | 760/760 | 0.5 | 14 |
| Second heating zone | 720/720 | 540/600 | 610/670 | 580/580 | 670/670 | 0.4 | 16 |
| Third heating zone | 650/650 | 500/560 | 570/630 | 540/540 | 630/630 | 0.3 | 18 |
| First slow cooling zone | 550/550 | 400/460 | 470/530 | 430/430 | 520/520 | 0.2 | 20 |
| Second slow cooling zone | 450/450 | 320/380 | 390/450 | 360/360 | 450/450 | 0.2 | 22 |
| Third slow cooling zone | 350/350 | 220/280 | 290/350 | 260/260 | 350/350 | 0.2 | 24 |
| First water cooling zone | | | | | | 0.2 | 26 |
| Second water cooling zone | | | | | | 0.2 | 28 |
| Third water cooling zone | | | | | | 0.2 | 30 |
| Fourth water cooling zone | | | | | | 0.2 | 32 |

The upper heaters in the first to sixth preheating zones, the first to third heating zones, the first to third slow cooling zones, and the first to fourth water cooling zones are configured to be movable up and down by the piston shaft, and are configured to press the forming die from above.

As a preparation for press forming, the lower heater and the upper heater of the chamber are powered on to heat each zone, and an inert atmosphere is set.

Then, a conveyance mechanism (not illustrated) conveys the forming die set with the glass base plate to the chamber, and positions the forming die in each zone for a predetermined time.

First, the forming die is preheated in the first to sixth preheating zones to soften the glass base plate to a press-formable temperature.

Then, in the first to third heating zones, the glass base plate is formed into a desired shape by increasing the pressurizing force.

Thereafter, the forming die and the formed glass are slowly cooled in the first to third slow cooling zones, and finally cooled until the glass reaches room temperature in the first to fourth water cooling zones, and taken out from the chamber.

### Examples 3 and 4

In Example 3, glass was obtained in the same manner as in Example 1 except for the composition conditions and forming temperature of the glass base plate. In Example 3, the forming temperature was set to 610° C. according to the difference in composition of the glass base plate. The composition of the glass base plate of Example 3 is shown in “glass material Y” in Table 1. The glass base plate (glass material Y) of Example 3 has a lower refractive index n_{d} than the glass base plate (glass material X) of Example 1. In Example 4, the same glass base plate (glass material Y) as in Example 3 was formed at a forming temperature of 680° C. by the same method as in Example 2 except for the forming temperature to obtain glass.

### Examples 5 and 6

In Example 5, glass was obtained in the same manner as in Example 1 except for the composition conditions and forming temperature of the glass base plate. In Example 5, the forming temperature was set to 643° C. according to the difference in composition of the glass base plate. The composition of the glass base plate of Example 5 is shown in “glass material A” in Table 1. The glass base plate (glass material A) of Example 5 has a lower refractive index n_{d} than the glass base plate (glass material X) of Example 1, but has a higher refractive index n_{d} than the glass base plate (glass material Y) of Example 3. In Example 6, the same glass base plate (glass material A) as in Example 5 was formed at a forming temperature of 770° C. by the same method as in Example 2 except for the forming temperature to obtain glass.

### Examples 7 and 8

In Example 7, a glass was obtained in the same manner as in Example 1 except for the composition conditions and forming temperature of the glass base plate. In Example 7, the forming temperature was set to 613° C. according to the difference in composition of the glass base plate. The composition of the glass base plate of Example 7 is shown in “glass material B” in Table 1. The glass base plate (glass material B) of Example 5 has a lower refractive index n_{d} than the glass base plate (glass material X) of Example 1, but has a higher refractive index n_{d} than the glass base plate (glass material Y) of Example 3. In Example 8, the same glass base plate (glass material B) as in Example 7 was formed at a forming temperature of 680° C. by the same method as in Example 2 except for the forming temperature to obtain glass.

### Examples 9 and 10

In Example 9, a glass was obtained in the same manner as in Example 1 except for the composition conditions and forming temperature of the glass base plate. In Example 9, the forming temperature was set to 675° C. according to the difference in composition of the glass base plate. The composition of the glass base plate of Example 9 is shown in “glass material C” in Table 1. The glass base plate (glass material C) of Example 9 has a lower refractive index n_{d} than the glass base plate (glass material X) of Example 1, but has a higher refractive index n_{d} than the glass base plate (glass material Y) of Example 3. In Example 10, the same glass base plate (glass material C) as in Example 9 was formed at a forming temperature of 770° C. in the same manner as in Example 2 except for the forming temperature to obtain glass.

### Measurement Items

Table 3 is a table showing the forming conditions of each example and the measurement results for each measurement item. For each glass obtained in Examples 1 to 10, each measurement item shown in Table 3 was measured as follows.

The plate thickness deviation of glass was measured by the method described in the present embodiment using a multi-color confocal laser displacement meter (CL-P030 manufactured by KEYENCE CORPORATION).

The rate of change in the curvature radius R of glass was measured by the method described in the present embodiment using a multi-color confocal laser displacement meter (CL-P030 manufactured by KEYENCE CORPORATION).

The retardation of glass was measured by irradiating light having a wavelength of 543 nm in the thickness direction using WPA-200 manufactured by Photonic Lattice.

The refractive index n_{d} of the glass was measured by a spectroscopic ellipsometry method (J. A. Woollam Co., Inc.; M-2000 DI).

The wavefront aberration of the glass was measured with a laser interferometer (manufactured by Zygo Corporation, Verifire). The laser used was a He—Ne laser and had a wavelength of 633 nm.

TABLE 3

| | Exam- | Exam- | Exam- | Exam- | Exam- | Exam- | Exam- | Exam- | Exam- | Exam- |
|---|---|---|---|---|---|---|---|---|---|---|
| | ple | ple | ple | ple | ple | ple | ple | ple | ple | ple |
| | 1 | 2 | 3 | 4 | 5 | 6 | 7 | 8 | 9 | 10 |
| Glass material | Glass | Glass | Glass | Glass | Glass | Glass | Glass | Glass | Glass | Glass |
| | material | material | material | material | material | material | material | material | material | material |
| | X | X | Y | Y | A | A | B | B | C | C |
| Forming apparatus | Batch | Continuous | Batch | Continuous | Batch | Continuous | Batch | Continuous | Batch | Continuous |
| Forming temperature [° C.] | 710 | 770 | 610 | 680 | 643 | 770 | 613 | 680 | 675 | 770 |
| (Maximum set | | | | | | | | | | |
| temperature) | | | | | | | | | | |
| Forming time [min] | 0.5 | 120 | 0.5 | 120 | 0.75 | 120 | 0.75 | 120 | 0.75 | 120 |
| Pressurizing force [kN] | 0.5 | 0.25 | 0.5 | 0.25 | 1 | 0.25 | 1 | 0.25 | 1 | 0.25 |
| Refractive index nd | 1.96 | 1.96 | 1.52 | 1.52 | 1.9 | 1.9 | 1.85 | 1.85 | 1.8 | 1.8 |
| (Wavelength 596 nm) | | | | | | | | | | |
| Plate thickness deviation | 0.25 | 4.79 | 0.26 | 0.85 | 0.30 | 0.47 | 0.15 | 0.90 | 0.27 | 0.45 |
| [%] | | | | | | | | | | |
| Rate of change of | 182 | 236 | 170 | 136 | 134 | 156 | 126 | 157 | 145 | 138 |
| curvature radius | | | | | | | | | | |
| (R > Average value) [%] | | | | | | | | | | |
| Rate of change of | 86 | 11 | 84 | 27 | 79 | 50 | 82 | 29 | 74 | 28 |
| curvature radius | | | | | | | | | | |
| (R < Average value) [%] | | | | | | | | | | |
| Retardation [nm/cm] | 14 | 43 | 12 | 32 | 19 | 44 | 18 | 90 | 18 | 60 |
| Wavefront aberration | 1.3 | 2.0 | 0.4 | 1.3 | 2.3 | 8.9 | 2.0 | 10.0 | 1.6 | 2.7 |
| (PV Value) [λ] | | | | | | | | | | |
| Wavefront aberration | 0.7 | 1.5 | 0.2 | 0.7 | 0.3 | 1.0 | 0.3 | 1.3 | 0.2 | 0.4 |
| (RMS) [λ] | | | | | | | | | | |

### Measurement Results

The measurement results of each measurement item are shown in Table 3. The refractive index n_{d} of the glass (glass material X) of Examples 1 and 2 was 1.96. The refractive index n_{d} of the glass (glass material Y) of Example 3 and Example 4 was 1.52. The refractive index n_{d} of the glass (glass material A) of Example 5 and Example 6 was 1.9. The refractive index n_{d} of the glass (glass material B) of Example 7 and Example 8 was 1.85. The refractive index n_{d} of the glass (glass material C) of Example 9 and Example 10 was 1.8. In Table 3, regarding the rate of change in the curvature radius R, the ratio of the maximum measured value to the average value is indicated in the item of (R>average value), and the ratio of the minimum measured value to the average value is indicated in the item of (R<average value). The internal transmittance (wavelength 460 nm) of each glass of Examples 1 to 10 is 89% or more in terms of a thickness of 10 mm.

### Evaluation

In Examples 1, 5, 7, and 9, even when a curved surface portion having a curvature radius of 10000 mm or less is formed on the glass having a refractive index n_{d} of 1.77 or more and an internal transmittance of 89% or more, the plate thickness deviation is kept within 1% or less of the maximum thickness. Therefore, even when a curved surface portion is formed on the glass material X having a high refractive index, deterioration of optical characteristics can be suppressed. On the other hand, in Example 2, even when a curved surface portion is formed on the glass material X having a high refractive index, the plate thickness deviation exceeds 1% of the maximum thickness, and therefore deterioration of optical characteristics cannot be suppressed. From the comparison between Example 2 and Examples 4, 6, 8, and 10, it can be seen that the refractive index n_{d} greatly affects the shape accuracy such as the plate thickness deviation. Furthermore, from comparison between Example 1 and Examples 3, 5, 7, and 9, it can be seen that the method for manufacturing a glass according to the present embodiment is suitable for a glass material having a high refractive index because the shape accuracy such as the plate thickness deviation is maintained despite the difference in the high refractive index. In Examples 3 and 4, the plate thickness deviation is kept within 1% or less of the maximum thickness, but since the refractive index n_{d} is less than 1.77, desired optical characteristics cannot be obtained in terms of the refractive index.

According to the present invention, even when a curved surface portion is formed on glass having a high refractive index, deterioration of optical characteristics can be suppressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A glass having
a refractive index n_{d} of 1.77 or more,
an internal transmittance of 10 mm in thickness with respect to light having a wavelength of 460 nm of 89% or more,
a curved surface portion having a curvature radius of 10000 mm or less in at least a part of a peripheral portion, and
a thickness deviation of 1% or less of a maximum thickness.

2. The glass according to claim 1, wherein the refractive index n_{d} is 1.80 or more.

3. The glass according to claim 1, wherein a retardation measured by irradiating the glass with light having a wavelength of 543 nm in a thickness direction is 40 nm/cm or less.

4. The glass according to claim 1, wherein an RMS value of wavefront aberration of the main surface measured with a laser interferometer is less than or equal to 0.7λ.

5. The glass according to claim 1, having one or more flat portions on an outer periphery of a main surface.

6. The glass according to claim 1, wherein the surface roughness Ra of the end face is 5 nm or more.

7. The glass according to claim 1 to, wherein the end face is painted black.

8. The glass according to claim 1, wherein an area of a main surface is 40 cm² or less.

9. The glass according to claim 1, wherein the thickness is 1.5 mm or less.

10. The glass according to claim 1, wherein a rate of change of a curvature radius in the curved surface portion with respect to an average value is 200% or less and 70% or more.

11. A method for manufacturing a glass having a curved surface portion, the method comprising:
heating a glass base plate;
applying an external force to the heated glass base plate to form the curved surface portion having a curvature radius of 10000 mm or less in at least a part of a peripheral portion of the glass base plate; and
obtaining the glass wherein
a refractive index n_{d} is 1.77 or more,
an internal transmittance of a thickness of 10 mm with respect to light having a wavelength of 460 nm is 89% or more, and
a thickness deviation is 1% or less of a maximum thickness.

12. The method for manufacturing a glass according to claim 11, wherein
the glass base plate has a temperature difference between a glass transition point and a softening point of 150° C. or less.

13. The method for manufacturing a glass according to claim 11, wherein when the glass base plate is heated, the glass base plate is heated together with a forming die by radiation heating from a heater disposed around the forming die in a state where the glass base plate is disposed in the forming die.

14. The method for manufacturing a glass according to claim 13, wherein a temperature of the forming die is monitored, and heating is stopped based on a fact that the temperature reaches a set temperature.

15. The method for manufacturing a glass according to claim 14, wherein
the forming die includes a first die and a second die to which the first die is fitted, and
a temperature difference between the first die and the second die when the set temperature is reached at the time of stopping heating is 60° C. or less.

16. The method for manufacturing a glass according to claim 11, wherein the glass base plate is heated at a temperature rise rate of 60° C./min or less.

17. The method for manufacturing a glass according to claim 11, wherein the glass base plate is formed by a batch forming apparatus.

18. The method for manufacturing a glass according to claim 17, wherein
the batch forming apparatus includes a forming die and a heater,
a temperature sensor is inserted into the forming die, and
a temperature difference of the forming die with respect to a set temperature of the heater during press forming is ±3 degrees or less.
